(19) United States
(12) Patent Application Publication
(10) Pub. No.: US 2004/0075279 A1
(43) Pub. Date: Apr. 22, 2004

(54) Wind powered electric generator

(76) Inventors: Newton Roi Breth, Salida, CO (US); Peter Scott Curtiss, Boulder, CO (US)

Correspondence Address: Newton Roi Breth, 47 Rex Circle, Salida, CO, 81201, US

(21) Appl. No.: 10/273,548

(22) Filed: Oct. 18, 2002

(51) Int. Cl. F03D 9/00; H02P 9/04

(52) U.S. Cl. 290/55

(57) ABSTRACT

A wind powered electric generator is provided with variable electric power output in accordance with wind speed. The wind powered electric generator has a multiple coil arrangement that allows electric power to be produced at low wind speeds as well as at high wind speeds. Also provided is multiple sealed coil packs with a magnetic coupling adjustment mechanism as well as a method and control system for controlling 0 through 100 percent power output of the wind powered electric generator in relation to wind speed.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of power generation and more specifically to a wind powered electric generator, in particular the invention relates to a megawatt wind powered electric generator that allows electric power to be produced at low wind speeds as well as at high wind speeds.

The present invention relates to a wind powered electric generator, in particular the invention relates to a megawatt wind powered electric generator that allows electric power to be produced at low wind speeds as well as at high wind speeds.

Various wind powered machines have been utilized over the years to pump water from wells and in later years to generate electric power. Early wind powered electric generators were widely used on farms that could not connect to commercial electric power due to long distances encountered to the nearest power lines. Today with pollution concerns from conventional fossil fueled electric power plants and a growing worldwide electrical generating capacity shortfall wind powered electric generators are now being used to supplement existing sources of electrical power. Several different types of wind powered electric generators are used to supplement existing electric power.

One type of wind powered electric generator employs moving permanent magnets to induce magnetic fields in coils of wire to produce electric power. When wind powered electric generators that employ permanent magnets are used to supplement existing power sources problems arise as to the control of electrical power output in low and high wind speeds limiting the use of permanent magnet type generators to small low power wind generating applications.

It is desirable to have a wind powered electric generator that utilizes permanent magnets while producing a high electrical power output in the megawatt range.

It is desirable to have a wind powered electric generator that does not require synchronization with existing power sources.

It is desirable to have a wind powered electric generator that produces electrical energy during low wind speed conditions to maximize the wind powered generators total yearly output of electric power.

Another concern in the use of wind powered electric generators is cost per kilowatt-hour of electrical energy produced. This includes the first cost to purchase the wind powered electric generator as well as the cost to maintain the electric generator during the generators life span. The lower the cost of maintenance performed on a wind powered electric generator, the more usable a wind powered electric generator becomes. It is desirable to have a wind powered electric generator design that allows unattended operation for long periods of time while requiring very little maintenance.

### BRIEF SUMMARY OF THE INVENTION

The primary object of the invention is to take advantage of the low wind speeds prevalent in most areas to make wind power an economical power production technology.

Another object of the invention is to provide a wind powered electric generator that utilizes moving permanent magnets to produce electric power during low and high wind speeds.

Another object of the invention is to provide a wind powered electric generator that utilizes moving permanent magnets with a multiple sealed coil arrangement and a magnetic coupling adjustment mechanism to control the electrical output of the wind powered generator in accordance with wind speed.

Another object of the invention is to provide a wind powered electric generator that utilizes moving permanent magnets to produce a high power output in the megawatt range.

Another object of the invention is to provide a wind powered electric generator that utilizes moving permanent magnets that does not require synchronization with existing power sources.

Another object of the invention is to provide a wind powered electric generator that utilizes moving permanent magnets that uses no more generator coils than required to produce electric power.

Another object of the invention is to provide a wind powered electric generator that utilizes moving permanent magnets to produce electric power during low wind speed conditions to maximize the wind powered generators total yearly output of electric power.

Another object of the invention is to provide a wind powered electric generator that utilizes moving permanent magnets that is low in initial cost and is inexpensive to maintain during the service life of the generator.

Another object of the invention is to provide a wind powered electric generator that utilizes moving permanent magnets that is simple to repair and is able to operate unattended for long periods of time without maintenance.

Another object of the invention is to provide a wind powered electric generator that allows continued generation of electric power while operating with one or more defective generator coils eliminating the need for a shutdown to make emergency repairs to the generator.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a megawatt-level wind powered electric generator comprising: A series of coil packs that allow for modular construction, and coil packs that allow the generator to produce power proportional to the wind speed.

The present invention relates to a wind powered electric generator mechanical arrangement and control. The generator comprises of a rotating propeller directly connected to a horizontal rotating shaft mounted in bearings and alternating pole permanent magnets axially mounted in relation to the shaft to a rotating drum that is affixed directly to the horizontal rotating shaft. A stationary outer drum with end plates support the rotating shaft bearings and a multitude of moveable coil packs that generate electricity when in alignment with the magnetic field of the permanent magnets mounted to the rotating drum.

Moveable coil packs consists of multiple C shaped layered stamped steel cores wrapped with several layers of wire forming a wire coil. Included with each coil is a liquid cooled bridge rectifier and fuses. In addition a liquid filled cooling coil is wrapped around the wire coils of each C shaped core. All parts are encapsulated in a potting compound forming a solid sealed rectangular coil pack structure with the legs of the C shaped cores protruding through the bottom of the coil pack.

The coil pack has provisions for a flexible electric cord with locking plug connected to the bridge rectifiers, fuses and for flexible braided hose connections to cool the liquid cooled bridge rectifier, wire coils of the coil pack with circulating cooling liquid. The coil packs are supported with spring return pneumatic cylinders and are located in rectangular cut holes in the stationary outer drum with guide plates to permit radial movement of the coil packs in relation to the stationary outer drum during actuation of the spring return pneumatic cylinders. The legs of the C shaped cores that protrude through the bottom of the coil pack move in and out of alignment with the magnetic field of the alternating poles of the magnets mounted to the inner rotating drum during movement of the coil pack increasing or decreasing the output of electric current from the coil pack.

Coil pack cords are plugged in to locking sockets located at the each end of the generators stationary outer drum and the DC power produced by the generator is connected with DC link cables to a inverter for conversion from DC current to AC current connected to a alternating current three-phase utility power line for distribution to consumers of electric power. Coil pack flexible braided hoses are connected to a common liquid filled header located at the middle of the generators stationary outer drum that in turn connects to an external to the generator fan coil fluid to air heat exchanger with a circulating pump to remove heat from the generator coil packs during power generation.

The loading of the generator coil packs in relation to available wind speed controls the shaft speed of the generator. The operating shaft speed is maintained at a predetermined target speed allowing the maximum amount of available generator shaft power to be converted to electric power. In addition only the coil packs that are required are used to produce electric power as the remaining unused coil packs are physically removed from the magnetic circuit of the alternating pole permanent magnets mounted on the inner rotating drum in turn removing all unneeded magnetic coupling and the resultant parasitic drag on the rotating shaft.

When the generator shaft speed increases due to higher wind speed above the predetermined target shaft speed more coil packs are loaded causing the DC link current to rise and the DC to AC inverter supplies more power to the three phase utility power line in turn placing more load on the generator shaft returning the generator shaft speed to the predetermined target shaft speed.

When the generator shaft speed decreases due to lower wind speed below the predetermined target shaft speed less coil packs are loaded causing the DC link current to fall and the DC to AC inverter supplies less power to the three phase utility power line in turn placing less load on the generator shaft returning the generator shaft speed to the predetermined target shaft speed.

In addition the coil pack loading sequence allows an infinite modulated coil pack loading between the minimum electrical power output of the generator and the maximum electrical power output of the generator through the use of the generator control systems pneumatic transducers that allow modulated control of the spring return pneumatic cylinders. The spring return pneumatic actuated cylinders react quickly to changing wind speeds to load and unload the coil packs in a predetermined sequence maintaining the predetermined target speed of the generator shaft and a stable DC link power output to the DC to AC inverter.

Below a predetermined generator shaft speed the generator is fully unloaded and the generator shaft speed is allowed to float until the predetermined target speed is reached. At this time the loading of the coil packs begins up to the ability of the generator to maintain the predetermined shaft target speed. At very high wind speeds all coil packs are loaded to the maximum loading producing the maximum rated output of the generator.

At wind speeds above the maximum of the predetermined shaft target speed built in airfoils on the propeller blades limit the generator shaft speed to a predetermined safe speed to keep the generator from operating in an over-speed condition. A brake disc mounted to the generator shaft on the opposite end of the generator from the propeller with calipers with brake pads mounted to the outer drum end plate are activated if an emergency over-speed condition exists that exceeds a predetermined safe generator shaft speed stopping the rotation of the generator shaft.

An optical encoder mounted on the stationary outer drum end plate opposite the propeller monitors the generator shaft speed through equally spaced holes in the brake disc that is mounted to the generator shaft. The optical encoder measures the generator shaft speed of rotation and sends a speed signal to the generators control system, which in turn controls the coil pack loading of the generator.

Maintenance involves yearly lubrication of two bearings. If a defective coil should develop the coil pack may be quickly replaced, as they are easily accessible on the stationary outer drum and are attached with two bolts. In addition the generator will continue to operate with one or more defective coil packs and replacement may be scheduled during regular maintenance avoiding an emergency generator shutdown for repairs.

The stationary outer drum is mounted on a on a rotating platform that allows the propeller of the generator to be properly orientated with respect to the direction of the wind. The rotating platform is supported on a suitable high vertical tower.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 shows a cross section view of various aspects of the wind powered electric generator.

FIG. 2 shows a top view of one of the wind powered generators coil packs.

FIG. 3 shows a side view of the coil pack shown in FIG. 2.

FIG. 4 shows a side view detail of one coil of the coil pack from FIGS. 2 and 3.

FIG. 5 shows a end view detail of one coil of the coil pack shown in FIG. 3.

FIG. 6 shows a side view of the front end plate of the generator shown in FIG. 1.

FIG. 7 shows a end view of the front end plate of the generator shown in FIG. 6.

FIG. 8 shows a side view of the rear end plate of the generator shown in FIG. 1.

FIG. 9 shows a schematic electrical diagram of the coil pack shown in FIGS. 2 and 3.

FIG. 10 shows a schematic fluid tubing diagram of the coil pack shown in FIGS. 2 and 3.

FIG. 11 shows a schematic electrical diagram of the generator shown in FIG. 1.

FIG. 12 shows a generator coil pack numbering arrangement.

FIG. 13 shows a block diagram of a generator control system.

FIG. 14 shows a detail side view of a cooling liquid header.

FIG. 15 shows a detail top view of a cooling liquid header.

FIG. 16 shows a block diagram of a cooling liquid fluid flow.

FIG. 17 shows a end view of a rotating inner drum.

FIG. 18 shows a side view of a rotating inner drum.

FIG. 19 shows a detail side view of the rotating inner drum.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The figures are all schematic representations of the different portions of this invention. Preferred embodiments of the present invention will now be described with reference to the accompanying drawings.

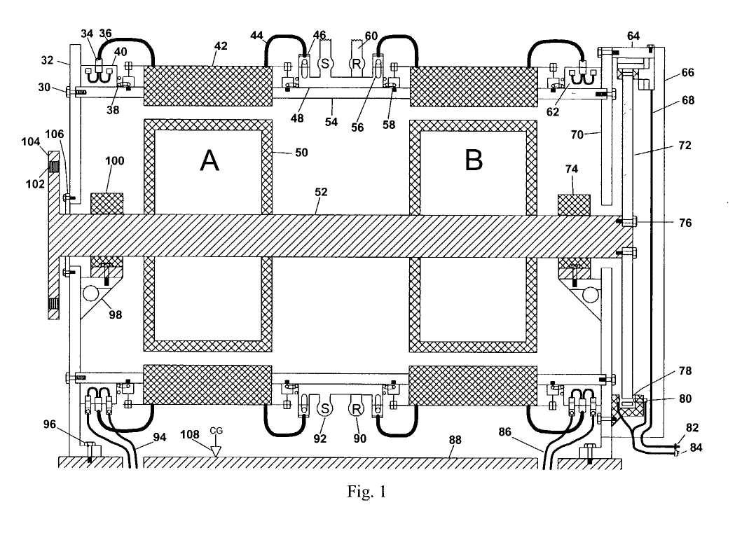

With reference to FIG. 1, (side view) a stationary outer drum 54 with end plates 32 and 70, bearings 100 and 74 support a rotating shaft 52. Rotating inner drums 50a and 50b are attached to attached to rotating shaft 52. One end of rotating shaft 52 has a propeller mounting hub 104 and propeller mounting bolts holes 102. The other end of rotating shaft 52 has a disc brake rotor 72 attached with disc brake mounting bolts 76. A Metal backed rubber dust seal 104 prevents entry of dust around rotating inner shaft 52. Disc brake calipers with pads and mounting bolts 64 are mounted to rear end plate 70. Also mounted to end plate 70 is optical encoder 78. Sheet metal end cover 66 covers the rear end of the generator.

With reference to FIG. 1 stationary outer drum 54 supports bus duct with bus bars and twist lock sockets 40. Stationary outer drum 54 supports cooling liquid header 48. Stationary outer drum 54 supports coil pack 42 and spring return pneumatic cylinder 58. Front end plate 32 and rear end plate 70 are mounted to steel I beam of a rotating platform.

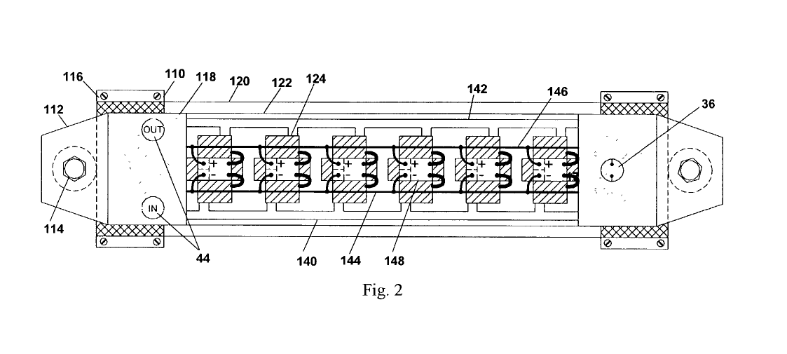

With reference to FIG. 2 (top view) coil pack 42 from FIG. 1. Coil pack 42 is mounted in hole in stationary outer drum 120 using metal backed PTFE coil pack guides 110 that are held in place with mounting screws 116. The spring return pneumatic cylinder rod 130 is fastened to coil pack spring return pneumatic cylinder mounting bracket with spring return pneumatic cylinder rod mounting nut 114. Coil pack 42 outer housing 122 has mounted within it coil 124. Rectifier 128 coil pack supply cooling header 140, coil pack return cooling header 142, minus coil pack wiring 144 and plus coil pack wiring 146.

With reference to FIG. 2 (top view) polyethylene mounting plate 118 provides a mounting location for cooling hoses supply and return 44. a polyethylene mounting plate similar to 118 provides a mounting location for a two wire rubber cord 36.

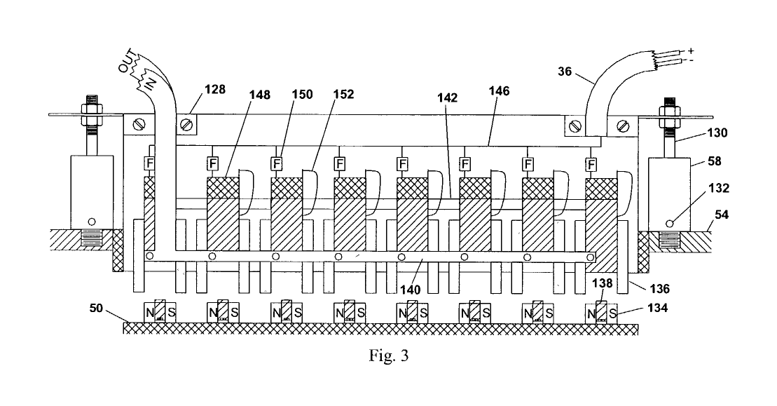

With reference to FIG. 3 (side view) coil pack 42 from FIG. 1. screws 128 hold polyethylene mounting plate 118 in place. Fuse 150 protects rectifier 128. Coil to rectifier wiring 152 connects coil to rectifier. Pneumatic tubing connection 132 is used to supply compressed air to the spring return pneumatic cylinder 58. Mounted to rotating inner drum 50a is permanent magnet 134 attached to rotating inner drum with magnet mounting clip with bolts 138.

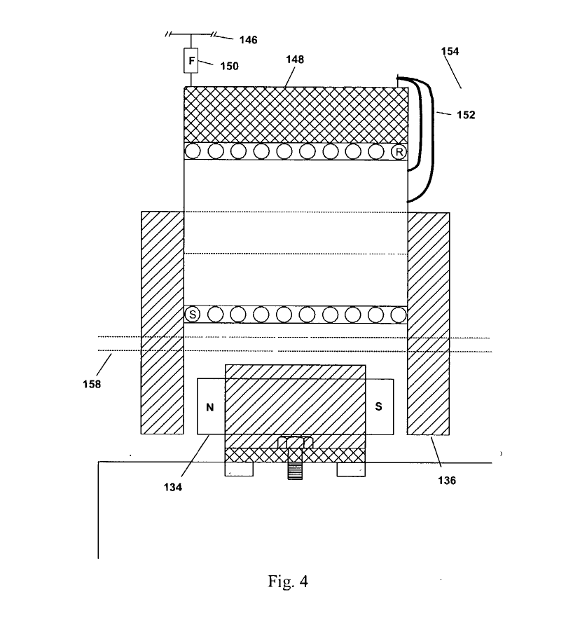

With reference to FIG. 4 (side view) of coil 124 from FIG. 2 protruding laminated transformer steel coil legs 136 protrude through bottom of coil pack housing 158. Rectifier bonded to cooling coil 160. Level of potting compound 154 holds coil 124 in place. Permanent magnet 134 from FIG. 2.

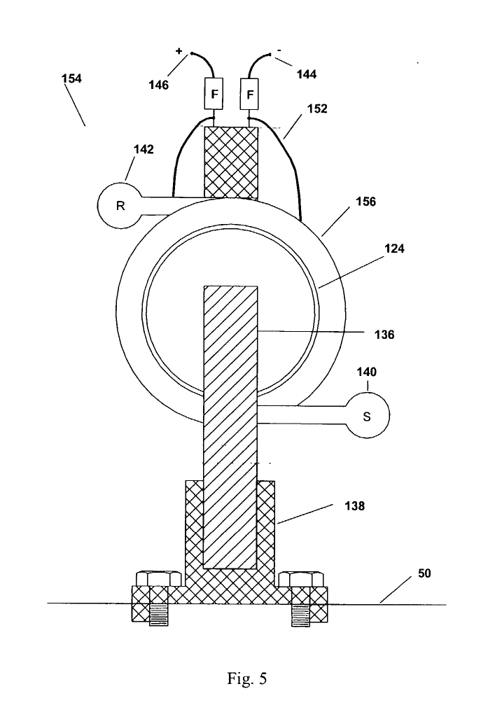

With reference to FIG. 5 (end view) of coil 124 and from FIG. 2. level of potting compound 154 holds coil 124 in place. Cooling tubing 156 removes heat from coil 124. Coil pack supply cooling header 140 is connected to one end of cooling tubing 156. Coil pack return header 142 is connected to the other end of cooling tubing 156.

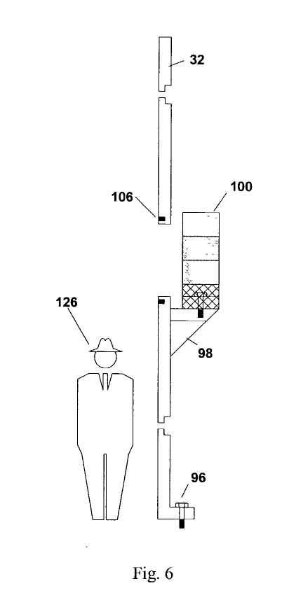

With reference to FIG. 6 (side view) of front end plate 32 from FIG. 1. Human form to indicate scale 126.

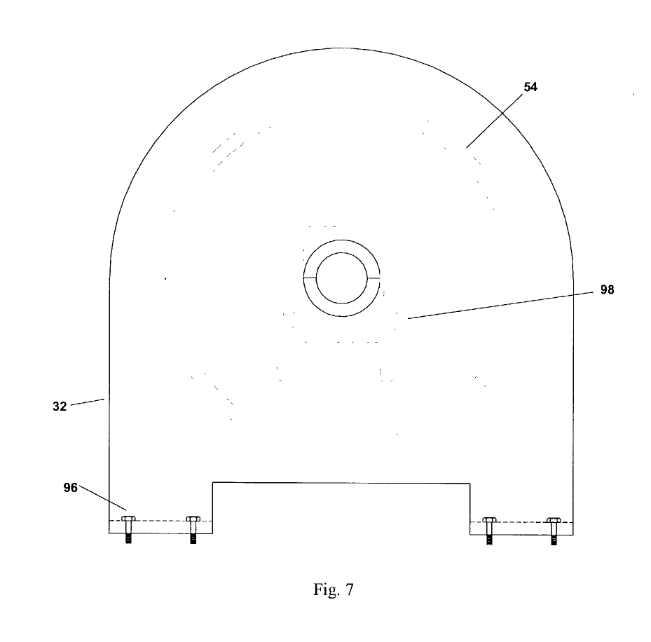

With reference to FIG. 7 (end view) of front end plate 32 from FIG. 1.

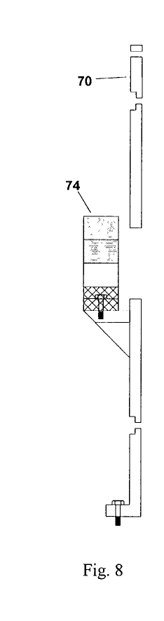

With reference to FIG. 8 (side view) of rear end plate 70 from FIG. 1.

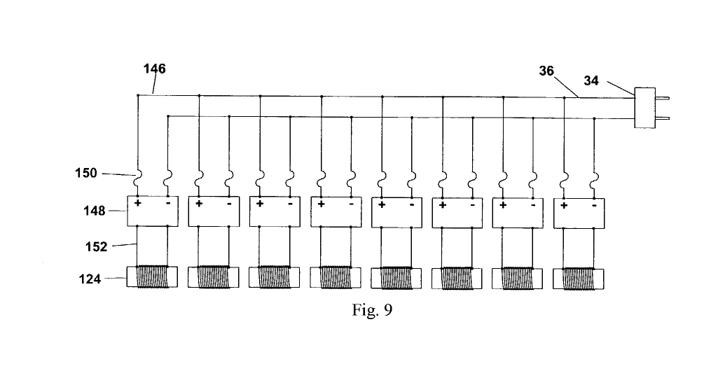

With reference to FIG. 9 schematic electrical diagram of the coil pack shown in FIG. 2 and FIG. 3. Coil 124 is connected to rectifier 148 with coil to rectifier wiring 152. Fuse protects rectifier 148. Plus coil pack wiring 146 is connected to two wire rubber cord 36 and two wire rubber cord 36 is connected to twist lock plug 34.

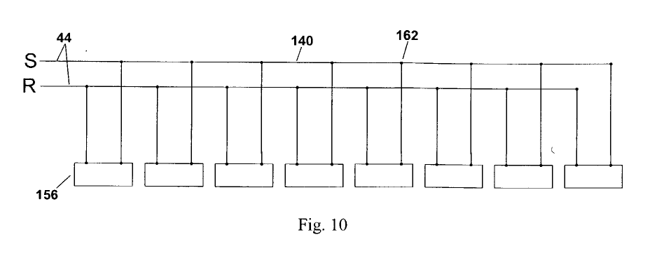

With reference to FIG. 10 schematic fluid tubing diagram of the coil pack shown in FIG. 3. Cooling tubing 156 connects to coil pack supply cooling hoses supply and return.

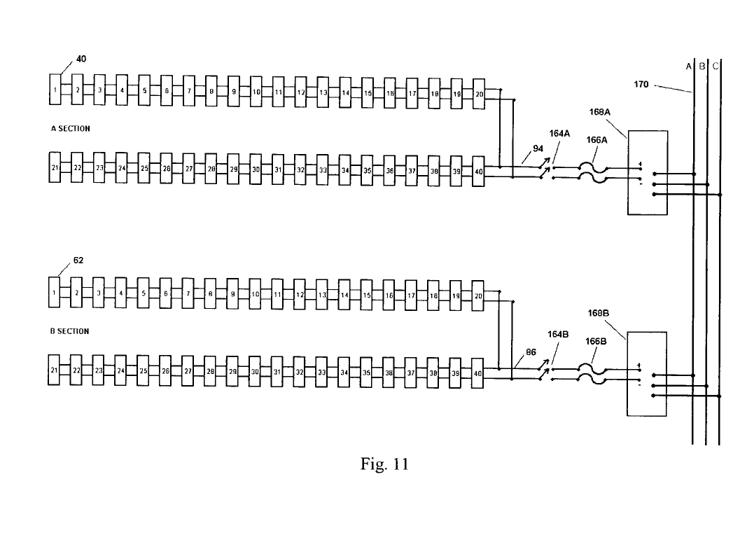

With reference to FIG. 11 schematic electrical diagram of the generator shown in FIG. 1 Bus duct with bus bars and twist lock sockets 40 is connected in parallel one through 40 to Section A DC link cables plus/minus 94. Section A DC link cables plus/minus 94 are connected to A section disconnect 164a and A section fuses 166a. A section DC to AC inverter 168a and to Three phase alternating current utility power line 170.

With reference to FIG. 11 schematic electrical diagram of the generator in FIG. 1 showing bus duct with bus bars and twist lock sockets 40 one through forty for A section of the generator. Section A DC link cables Plus and minus 94 connect bus duct with bus bars and twist lock sockets 40 to A section disconnect 164a. is connected to A section fuses 166a. A section fuses 166a are connected to A section DC to AC inverter 168a which is connected to three phase alternating current utility power line. B section of FIG. 11 is identical to A section.

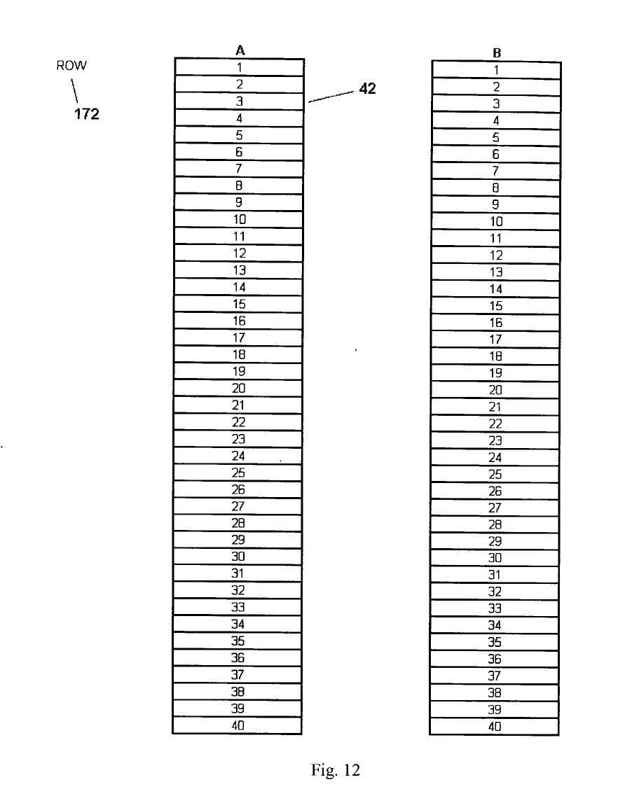

With reference to FIG. 12 generator coil pack numbering arrangement. Row A one through forty 172 provides the mounting arrangement for coil pack 42 around stationary outer drum 54 from FIG. 1. B section is identical to A section

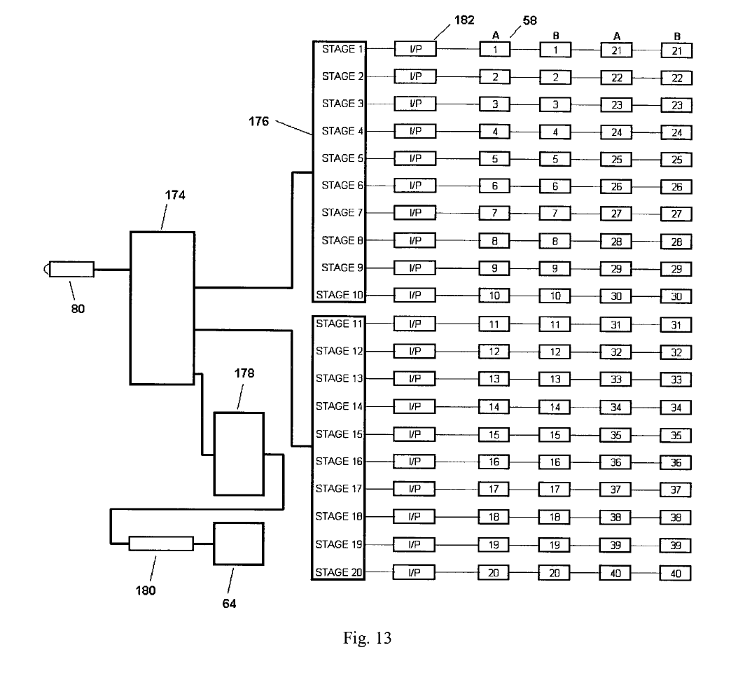

With reference to FIG. 13 block diagram of the generator control system. FIG. 13 shows the operation of the generator control system. Optical speed sensor 80 generates a signal indicating disc brake rotor with holes for optical speed sensor 72 and rotating shaft 52 from FIG. 1 rotational speed. The signal from the optical speed sensor 80 indicating generator shaft speed is sent to the input of generator control system 174. The generator control system 174 sends output current signals one through twenty stages to analog output card for coil pack loading 176 which is then converted to a pneumatic output by I to P current to pneumatic transducer 182. The pneumatic signal from the I to P current to pneumatic transducer 182 is sent to spring return pneumatic cylinder 58 to load coil pack 42

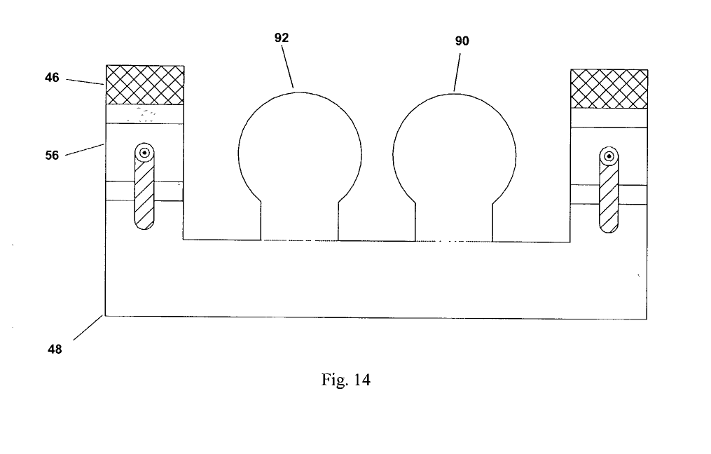

With reference to FIG. 14 detail side view of a cooling liquid header. FIG. 14 shows the supply pipe of cooling header 92 and return pipe of cooling header 90 that is connected to cooling liquid header 48. Shutoff ball valve 56 is mounted to cooling liquid header 48. To the other end of shut off ball valve 56 is connected hose connection 46 Hose connection 46 connects to Coil pack 42 FIG. 1 via cooling hose supply and return 44.

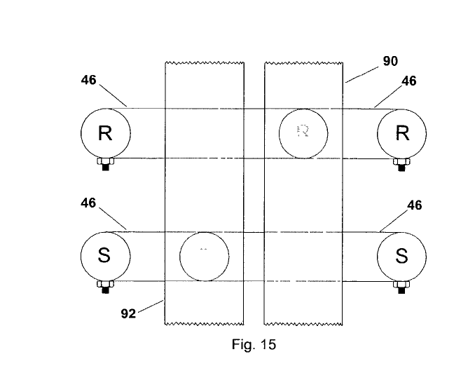

With reference to FIG. 15 detail top view of a cooling liquid header shows the location of supply pipe of cooling header 92 and return pipe of cooling header 90 shown in FIG. 14.

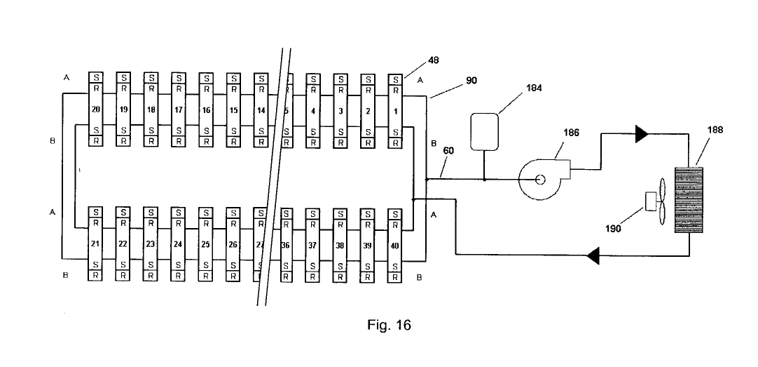

With reference to FIG. 16 block diagram of a cooling liquid flow. FIG. 16 Shows the liquid cooling flow through coil pack 42 FIG. 1 one through forty. Cooling liquid header 48 through return pipe of cooling header 90 connects to cooling liquid header connections 60 then to cooling fluid circulating pump 186. Cooling fluid circulating pump 186 is connected to liquid to air heat exchanger 188 cooling fan 190 removes heat from Liquid to air heat exchanger 188. Pressure tank 184 is connected to cooling liquid header connections 60.

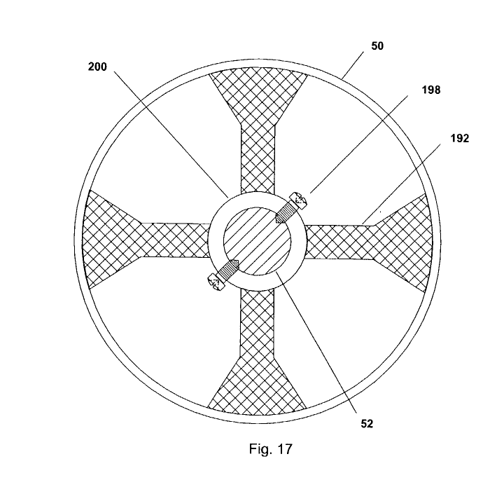

With reference to FIG. 17 end view of a rotating inner drum. Rotating shaft 52 supports rotating inner drum support struts 192 through shaft collar 200. shaft collar 200 is secured to rotating shaft 52 with set screws 198. rotating inner drum support struts 192 support rotating inner drum 50.

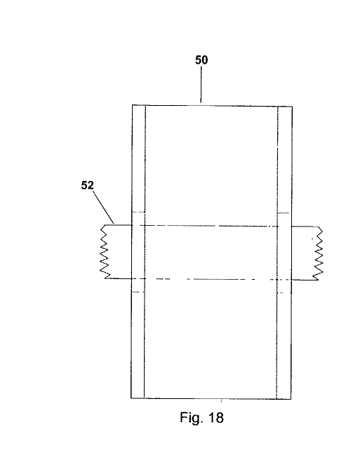

With reference to FIG. 18 side view of a rotating inner drum shows a side view of rotating inner drum from FIG. 17 rotating shaft 52 and rotating inner drum 50.

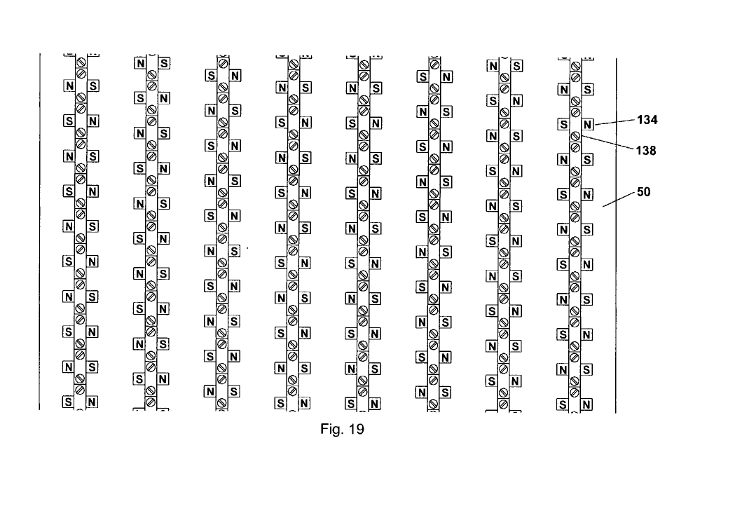

With reference to FIG. 19 detail side view of the rotating inner drum shows the location of permanent magnets showing north and south poles 134 from FIG. 4 attached to rotating inner drum 50 from FIG. 17 with magnet mounting clips with bolts 138. from FIG. 2

The figures show schematic drawings of the invention. The parts on each figure are given by the reference numbers.

30 End plate bolts.

32 Front end plate.

34 Twist lock plug.

36 Two wire rubber cord.

38 Pneumatic tubing header.

40 Bus duct bus bars and twist lock sockets, A section.

42 Coil pack.

44 Cooling hoses supply and return.

46 Hose connection.

48 Cooling liquid header.

50 Rotating inner drum.

52 Rotating shaft.

54 Stationary outer drum.

56 Shutoff ball valve.

58 Pneumatic spring return cylinder.

60 Cooling liquid header connections.

62 Bus duct bus bars and twist lock sockets, B section.

64 Disc brake calipers.

66 Sheet metal end cover.

68 Pneumatic disc brake line.

70 Rear end plate.

72 Disc brake rotor.

74 Rear bearing.

76 Disc brake rotor mounting bolts.

78 Holes in disc brake rotor

80 Optical encoder.

82 Brake caliper air tubing.

84 Plug to connect optical encoder.

86 Section B DC link cables plus/minus to DC to AC inverter.

88 Steel I beam base plate.

90 Return pipe of cooling header.

92 Supply pipe of cooling header.

94 Section A DC link cables plus/minus to DC to AC inverter.

96 End plate bolts.

98 Bearing support.

100 Front bearing radial thrust type.

102 Propeller mounting bolts.

104 Propeller mounting flange.

106 Metal backed rubber dust seal.

108 Approximate center of gravity.

110 Metal backed PTFE coil pack guides.

112 Spring return pneumatic cylinder mounting bracket.

114 Spring return pneumatic cylinder rod mounting nut.

116 Mounting screws.

118 Polyethylene mounting plates.

120 Edge of rectangle hole in stationary outer drum.

122 Coil pack housing.

124 One coil of eight.

126 Human form.

128 Screws.

130 Spring return pneumatic cylinder rod.

132 Pneumatic tubing connection.

134 Permanent magnets.

136 Protruding laminated transformer steel coil legs.

138 Magnet mounting clips.

140 Coil pack supply cooling header.

142 Coil pack return cooling header.

144 Minus coil pack wiring.

146 Plus coil pack wiring.

148 Rectifier.

150 Fuses.

152 Coil to rectifier wiring.

154 Level of potting compound.

156 Cooling tubing.

158 Bottom of coil pack housing.

162 Tee connection.

164a A section disconnect.

164b B section disconnect.

166a A section fuses.

166b B section fuses.

168a A section DC to AC inverter.

168b B section DC to AC inverter.

170 Three phase alternating current utility power line.

172 Row A one through forty.

174 Generator control system.

176 Analog output card.

178 Analog output card.

180 I to P current to pneumatic transducer.

182 I to P current to pneumatic transducer.

184 Pressure tank.

186 Cooling fluid circulating pump.

188 Liquid to air heat exchanger.

190 Cooling fan.

192 Rotating inner drum support struts.

198 Set screws.

200 Shaft collar.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An megawatt wind powered electric generator comprising:
a stationary outer drum;
a plurality of moveable coil packs;
a plurality of wire coils mounted in said moveable coil packs;
a plurality of C shaped cores protruding from said moveable coil packs;
a rotating inner drum;
a horizontal rotating shaft which said rotating inner drum is attached;
said horizontal rotating shaft to which a disc brake rotor is attached;
said horizontal rotating shaft to which rotational power may be applied.

2. An megawatt wind powered electric generator of claim 1 wherein;
said stationary outer drum has a plurality of holes for mounting of said moveable coil packs;
said moveable coil packs are attached to said stationary outer drum with spring return pneumatic cylinders;
said spring return pneumatic cylinders are automatically controlled in a predetermined sequence with relation to said horizontal rotating shaft speed;
said rotating inner drum has a plurality of alternating pole permanent magnets attached to surface of said rotating inner drum.

3. An megawatt wind powered electric generator of claim 2 further including;
said C shaped cores protruding from said moveable coil packs magnetically interact with said alternating pole permanent magnets to produce a controlled electric power output of said moveable coil pack;
said spring return pneumatic cylinders control the magnetic interaction between said C shaped cores and said alternating pole permanent magnets by moving said moveable coil packs in and out of alignment of said alternating pole permanent magnets;
said C shaped cores may be positioned at any point of alignment from zero to one hundred percent with said alternating pole permanent magnets that are attached to said rotating inner drum by using said spring return pneumatic cylinders to change the position of said moveable coil packs to vary the electrical output of the said moveable coil packs from zero to one hundred percent;
said C shaped cores of said moveable coil pack are physically removed from the magnetic interaction of said alternating pole permanent magnets that are attached to the surface of said rotating inner drum when electric power is not being produced allowing complete removal of parasitic drag due to magnetic interaction between said C shaped core of said moveable coil packs and said alternating pole permanent magnets that are attached to said rotating inner drum.

4. In a wind generator having a rotatable wind powered shaft, said shaft having a magnet affixed thereto, an outer drum mounted at a distance beyond an outer periphery of the magnet, the outer drum having a coil, wherein a rotation of the magnet past the coil generates an electric output from the coil, and wherein the rotation of the magnet past the coil also creates a parasitic drag on the magnet, the improvement comprising:
a variable distance coil mounting assembly on the outer drum; and
wherein a distance between the magnet and the coil can be varied.

5. The apparatus of claim 4, wherein the magnet is a permanent magnet, and the coil further comprises a C shaped core partially surrounding the magnet on three sides in a coupled mode.

6. The apparatus of claim 5 further comprising a powered actuator in the variable distance coil mounting assembly to move the coil.

7. The apparatus of claim 6 further comprising a rotation speed sensor to detect a shaft rotation speed.

8. The apparatus of claim 7 further comprising a control system which receives the sensed shaft rotation speed and adjusts the powered actuator in relation to the speed, thereby moving the coil away from the magnet as the speed decreases.

9. The apparatus of claim 8, wherein the coil further comprises a coil pack assembly having a plurality of coils connected in parallel, and wherein the magnet further comprises a plurality of rings of magnets mounted on an inner drum which is mounted on the shaft such that each ring of magnets passes by a separate coil.

10. The apparatus of claim 9 further comprising a plurality of coil pack assemblies, the plurality being an even number.

11. The apparatus of claim 10, wherein the control system controls an opposing set of coil pack assemblies, thereby maintaining a balanced radial parasitic drag on the shaft.

12. The apparatus of claim 11 further comprising a plurality of sets of magnet rings and coil pack assemblies.

13. The apparatus of claim 11, wherein each coil pack assembly further comprises an internal coolant circuit, and each coil pack assembly further comprises a cooling inlet and outlet.

14. The apparatus of claim 13, wherein the control system activates a brake in an over speed condition.

15. The apparatus of claim 8, wherein the control system further comprises a range of coil to magnet distance varying from a fully coupled condition to a minimally coupled condition.

16. A wind generator comprising:
a wind powered rotating shaft;
a magnet affixed to the said shaft;
a variable distance coil mounting assembly mounted outbound from a circular path made by a rotation of the magnet and the shaft; and
wherein a distance between the magnet and a coil in the variable distance coil mounting assembly can be varied by the variable distance coil mounting assembly.

17. The apparatus of claim 16, wherein the magnet is a permanent magnet, and the coil further comprises a C shaped core partially surrounding the magnet on three sides in a coupled mode.

18. The apparatus of claim 17 further comprising a powered actuator in the variable distance coil mounting assembly to move the coil.

19. The apparatus of claim 18 further comprising a rotation speed sensor to detect a shaft rotation speed.

20. The apparatus of claim 19 further comprising a control system which receives the sensed shaft rotation speed and adjusts the powered actuator in relation to the speed, thereby moving the coil away from the magnet as the speed decreases.

21. The apparatus of claim 20, wherein the coil further comprises a coil pack assembly having a plurality of coils connected in parallel, and wherein the magnet further comprises a plurality of rings of magnets mounted on an inner drum which is mounted on the shaft such that each ring of magnets passes by a separate coil.

22. The apparatus of claim 21 further comprising a plurality of coil pack assemblies, the plurality being an even number.

23. The apparatus of claim 22, wherein the control system controls an opposing set of coil pack assemblies, thereby maintaining a balanced radial parasitic drag on the shaft.

24. The apparatus of claim 23 further comprising a plurality of sets of magnet rings and coil pack assemblies.

25. The apparatus of claim 23, wherein each coil pack assembly further comprises an internal coolant circuit, and each coil pack assembly further comprises a cooling inlet and outlet.

26. The apparatus of claim 25, wherein the control system activates a brake in an over speed condition.

27. The apparatus of claim 20, wherein the control system further comprises a range of coil to magnet distance varying from a fully coupled condition to a minimally coupled condition.

28. A wind generator comprising:
a wind powered rotating shaft means functioning to rotate at least one magnet attached thereto;
a magnet means functioning to generate a current when rotated adjacent to a coil
said magnet means affixed to said shaft; and
a variable distance coil mounting assembly means functioning to move at least one coil a variable distance from the magnet to vary a current generated in the coil and vary a parasitic drag on the coil.
References Cited

| | | |
|---|---|---|
| 5834874 | November 1998 | Krueger et al. |
| 3525005 | August 1970 | Beyers |
| 5786645 | July 1998 | Obidniak |
| 3401290 | May 1966 | Potter |
| 4578609 | March 1986 | McCarty |
| 4211945 | July 1980 | Ian S. Tawse |
| 4305031 | December 1981 | Wharton |
| 6191561 | Febraury 2001 | Bartel |
| 5696419 | December 1997 | Rakestraw |
| 4318019 | March 1982 | Teasley et al. |
| 4475075 | October 1984 | Munn |
| 4639626 | January 1987 | McGee |
| 2993159 | July 1961 | L. Devol |
